(19) United States
(12) Patent Application Publication
(10) Pub. No.: US 2026/0014929 A1
(43) Pub. Date: Jan. 15, 2026

(54) SYSTEMS AND METHODS FOR USING TRACTOR-TRAILER ALIGNMENT FOR CONTROLLING SELF-CANCELLING TURN SIGNALS

(71) Applicants: Hyundai Motor Company, Seoul (KR); Kia Corporation, Seoul (KR)

(72) Inventor: Peter A. Montero, Superior Township, MI (US)

(21) Appl. No.: 18/773,222

(22) Filed: Jul. 15, 2024

(51) Int. Cl. B60Q 1/34; B62D 15/02

(52) U.S. Cl. CPC B60Q 1/346; B60Q 1/343; B62D 15/021

(57) ABSTRACT

A turn signal control system and method for controlling a turn signal are provided. The turn signal control system may comprise one or more sensors, coupled to a tractor-trailer. The tractor-trailer may comprises a tractor portion and a trailer portion. The one or more sensors may be configured to detect one or more data points pertaining to a position of the tractor portion in relation to the trailer portion. The turn signal control system may comprise one or more computing devices, each comprising a processor and a memory, configured to analyze the one or more data points to determine an angle between the tractor portion and the trailer portion, and a controller configured to automatically cancel a turn signal based on one or more factors. The one or more factors may comprise the angle between the tractor portion and the trailer portion.

### BACKGROUND

### Technical Field

Embodiments of the present disclosure relate to systems and methods for using tractor-trailer alignment for controlling self-cancelling turn signals.

### Background

For a tractor-trailer, the overall length of the combination of tractor and trailer may be over 73 feet. Of that 73 feet, 53 feet may be the length of the trailer. When a Class 8 tractor-trailer is making relatively sharp turns, the driver may need to turn the tractor's wheels counter to the direction of the overall trajectory of the trailer.

Self-cancelling turn signals use changes in steering angle and/or a timer in order to determine when to cancel the turn signal. However, self-cancelling turn signals do not determine an actual turn progress of a vehicle and frequently cancel turn signals too early. Though self-cancelling turn signals are standard on all passenger vehicles, and highly valued as a convenience and safety feature, their design may not be intelligent enough to understand when to accurately cancel turn signals on a Class 8 tractor-trailer combination, since moves turning may require a tractor to turn left and right. For example, while performing a “Button Hook” turn, to make a right turn, the tractor may be required to continue straight passed an apex of the turn, turn right, and then correct to left in order to lead the trailer around an obstacle on an inside of the right turn.

In the Button 1-look turn and other common turning scenarios, tractor-trailer turn signals may self-cancel based on the steering inputs on the tractor, although the trailer is still continuing in its turn.

To address the issues with using self-cancelling turn signals on tractor-trailers, some drivers are forced to re-apply the turn signals while the tractor-trailer is in mid-turn or risk finishing the turn with the trailer in a vulnerable condition, Some Original Equipment Manufacturers (OEMs), on the other hand, have simply pursued the tactic of not offering self-cancelling turn signals as standard equipment as a way of addressing the issues with using self-cancelling turn signals on tractor-trailers.

For at least these reasons, a self-cancelling turn signal control system and method of use is needed for use in tractor-trailers that addresses the turning needs of tractor-trailers.

### SUMMARY

According to an object of the present disclosure, a turn signal control system is provided. The turn signal control system may comprise one or more sensors, coupled to a tractor-trailer. The tractor-trailer may comprises a tractor portion and a trailer portion. The one or more sensors may be configured to detect one or more data points pertaining to a position of the tractor portion in relation to the trailer portion. The turn signal control system may comprise one or more computing devices, each comprising a processor and a memory, configured to analyze the one or more data points to determine an angle between the tractor portion and the trailer portion, and a controller configured to automatically cancel a turn signal based on one or more factors. The one or more factors may comprise the angle between the tractor portion and the trailer portion.

According to an exemplary embodiment, the tractor-trailer may comprise a steering component and a steering angle sensor configured to detect a steering angle of the steering component. The one or more factors may further comprise the angle of the steering component.

According to an exemplary embodiment, the turn signal control system may comprise a manual turn signal actuator configured to enable a driver to actuate a turn signal such that the turn signal has an on status and a direction.

According to an exemplary embodiment, the computing device may be configured to determine whether the angle between the tractor portion and the trailer portion is less than 180°.

According to an exemplary embodiment, the controller may be configured to maintain an on status of the turn signal when the angle between the tractor portion and the trailer portion is less than 180°.

According to an exemplary embodiment, when the angle between the tractor portion and the trailer portion is not less than 180°, the computing device may be configured to determine whether the angle between the tractor portion and the trailer portion equals 180°,

According to an exemplary embodiment, when the angle between the tractor portion and the trailer portion is equal to 180° for a set amount of time, the controller may be configured to cancel the turn signal, causing the turn signal to have an off status.

According to an exemplary embodiment, the turn signal control system may comprise the tractor-trailer.

According to an exemplary embodiment, the tractor-trailer may comprise one or more left turn signal indicators configured to indicate that the turn signal is a left turn signal with an on status and one or more right turn signal indicators configured to indicate that the turn signal is a right turn signal is a right turn signal with an on status.

According to an exemplary embodiment, the tractor-trailer may comprise a fifth wheel. According to an exemplary embodiment, the one or more sensors may be coupled to the fifth wheel.

According to an object of the present disclosure, a method for controlling a turn signal is provided. The method may comprise detecting, using one or more sensors coupled to a tractor-trailer, one or more data points pertaining to a position of a tractor portion of the tractor-trailer in relation to a trailer portion of the tractor trailer, analyzing, using one or more computing devices, each comprising a processor and a memory, the one or more data points to determine an angle between the tractor portion and the trailer portion, and, using a controller, automatically cancelling a turn signal based on one or more factors. The one or more factors may comprise the angle between the tractor portion and the trailer portion.

According to an exemplary embodiment, the tractor-trailer may comprise a steering component and a steering angle sensor configured to detect a steering angle of the steering component. According to an exemplary embodiment, the one or more factors may comprise the angle of the steering component. According to an exemplary embodiment, the method may further comprise detecting, using the steering angle sensor, the angle of the steering component.

According to an exemplary embodiment, the method may further comprise actuating, using a manual turn signal actuator, the turn signal such that the turn signal has an on status and a direction.

According to an exemplary embodiment, the manual turn signal actuator may be configured to enable a driver to actuate the turn signal.

According to an exemplary embodiment, the method may further comprise determining, using the computing device, whether the angle between the tractor portion and the trailer portion is less than 180°.

According to an exemplary embodiment, the method nay further comprise maintaining, using the controller, an on status of the turn signal when the angle between the tractor portion and the trailer portion is less than 180°.

According to an exemplary embodiment, the method may further comprise, when the angle between the tractor portion and the trailer portion is not less than 180°, determining, using the computing device, whether the angle between the tractor portion and the trailer portion equals 180°.

According to an exemplary embodiment, the method may further comprise, when the angle between the tractor portion and the trailer portion is equal to 180° for a set amount of time, cancelling, using the controller, the turn signal, causing the turn signal to have an off status.

According to an exemplary embodiment, the tractor-trailer may comprise one or more left turn signal indicators configured to indicate that the turn signal is a left turn signal with an on status, and one or more right turn signal indicators configured to indicate that the turn signal is a right turn signal is a right turn signal with an on status.

According to an exemplary embodiment, the tractor-trailer may comprise a fifth wheel. According to an exemplary embodiment, the one or more sensors may be coupled to the fifth wheel.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 illustrates a tractor-trailer comprising a turn signal control system, according to an exemplary embodiment of the present disclosure.

FIGS. 2A-2B illustrates a method of activating and cancelling a turn signal in a tractor-trailer, according to an exemplary embodiment of the present disclosure,

FIG. 3 illustrates an example architecture of a vehicle, according to an exemplary embodiment of the present disclosure.

FIG. 4 illustrates example elements of a computing device, according to an exemplary embodiment of the present disclosure.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPIs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

According to exemplary embodiments, a winching system integrated with vehicle control is provided.

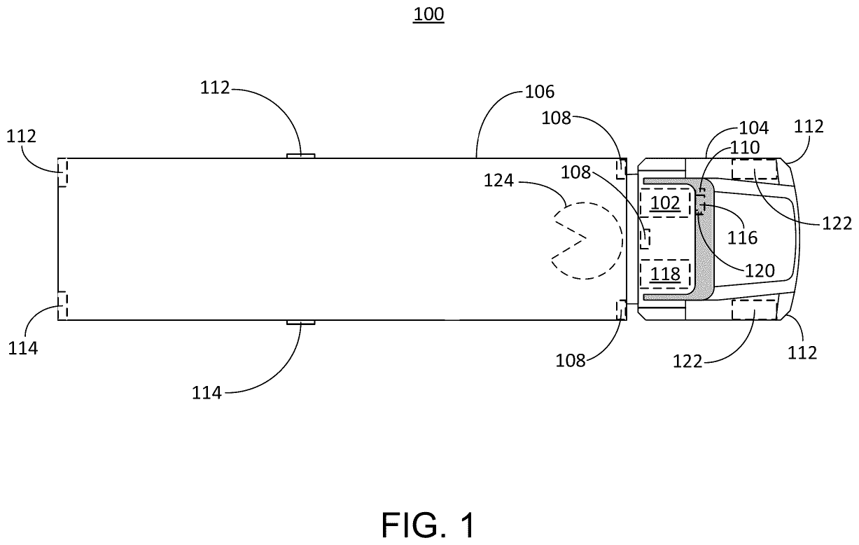

Referring now to FIG. 1, a tractor-trailer 100 comprising a turn signal system controller 102 is illustratively depicted, in accordance with an exemplary embodiment of the present disclosure.

According to an exemplary embodiment, the tractor-trailer 100 may comprise a tractor portion 104 coupled to a trailer portion 106. The tractor-trailer 100 may comprise one or more sensors 108 configured to measure an angle between the tractor portion 104 and the trailer portion 106. The one or more sensors 108 may be coupled to the tractor portion 104 and/or the trailer portion 106. The one or more sensors 108 may be coupled and/or incorporated into the kingpin/fifth wheel 124 of the tractor-trailer 100 and/or coupled to any other suitable part or parts of the tractor-trailer 100. The one or more sensors 108 may comprise one or more cameras, one or more LiDAR sensors, one or more RADAR sensors, may be one or more components of an advanced driver assistance system (ADAS), and/or other suitable types of sensors. According to an exemplary embodiment, when the one or more sensors 108 are coupled to the kingpin/fifth wheel 124, the one or more sensors 108 may comprise one or more rotation sensors configured to detected when the tractor portion 104 and the trailer portion 106 are not aligned.

According to an exemplary embodiment, the tractor-trailer 100 may comprise a manual turn signal actuator 110 (e.g., a turn signal stalk) configured to enable a driver to manually activate and/or cancel a turn signal operation. According to an exemplary embodiment, the tractor-trailer 100 may comprise one or more external left turn signals indicators 112 (e.g., a front left turn signal indicator, a rear left turn signal indicator, a side left turn signal indicator, etc.) configured to indicate (via, e.g., light signaling and/or other suitable means) that a left turn signal has an on status, and one or more external right turn signal indicators 114 (e.g., a front right turn signal indicator, a rear right turn signal indicator, a side right turn signal indicator, etc.) configured to indicate (via, e.g., light signaling and/or other suitable means) that a right turn signal has an on status.

According to an exemplary embodiment, the turn signal system controller 102 may be configured to determine when to automatically cancel a turn-signal based on one or more factors. The one or more factors may comprise an angle between the tractor portion 104 and the trailer portion 106 (based on the one or more sensors 108), a steering angle of a steering component 116 (e.g., a steering wheel), and/or other suitable factors. According to an exemplary embodiment, the steering component 116 may be configured to rotate one or more front wheels 122 of the tractor portion 104 of the tractor-trailer 100, enabling the tractor-trailer 100 to steer.

According to an exemplary embodiment, the tractor-trailer 100 may comprise one or more computing devices 118. The one or more computing devices 118 may comprise one or more processors and/or memory. The one or more computing devices 118 may be a component of the turn signal system controller 102 and/or be in electronic communication with the turn signal system controller 102. According to an exemplary embodiment, the one or more computing devices 118 may be configured to enable the processor to cause the tractor-trailer 100 and/or a turn signal control system to perform one or more functions.

According to an exemplary embodiment, the turn signal control system may comprise the turn signal system controller 102, the one or more sensors 108, the manual turn signal actuator 110, the one or more left turn signal indicators 112, the one or more right turn signal indicators 114, the steering component 116, and/or the one or more computing devices 118. According to an exemplary embodiment, the steering component 116 may comprise one or more sensors 120 configured to sense an angle of the steering component (e.g., a steering angle sensor), According to an exemplary embodiment, the one or more computing devices 118 and/or the turn signal system controller 102 may be in electronic communication with the one or more sensors 108 and/or the steering angle sensor 120.

According to an exemplary embodiment, the turn signal control system may be configured to ensure that the turn signals (e.g., turn signal indicators 114, 116) of a tractor-trailer 100 remain actuated, even when, during turning maneuvers, a driver applies a steering input (via, e.g., the steering component 116) in a direction opposite a direction of the turn signal (e.g., a left turn signal or a right turn signal). This is an improvement upon existing self-cancelling turn signals in that, when the driver applies a steering input in a direction opposite a direction of the turn signal, existing self-cancelling turn signals would normally cancel the turn signal, even if the driver were still in the process of performing a turning maneuver.

According to an exemplary embodiment, the one or more sensors 108 may be configured to sense an orientation of the tractor portion 104 to the trailer portion 106 in order to determine when the tractor portion 104 and the trailer portion 106 are not aligned. According to an exemplary embodiment, sensing when the tractor portion 104 and the trailer portion 106 are not aligned, and the orientation between the tractor portion 104 and the trailer portion 106 is crucial to intelligently sensing a direction of a turn of the tractor-trailer 100, For example, the orientation of the trailer portion 106 to the tractor portion 104 determines a direction of turn and provides key information to the turn signal control system in determining whether or not the turn signal system controller 102 should self-cancel the turn signal. According to an exemplary embodiment, this orientation-defined direction of turn is accurate while the tractor-trailer 100 is driving forward and in reverse.

According to an exemplary embodiment, the one or more computing devices 118 may be configured to determine, based on one or more data points collected by the one or more sensors 108 and/or the steering angle sensor 120, to determine a trajectory of mid-maneuvering steering of the tractor-trailer 100. For example, the one or more computing devices may be configured to recognize a combination of status events related to a direction of tractor-trailer 100 movement. The one or more status events may comprise, but are not limited to, actuation of a turn signal stalk 110 (including an indicated direction of the turn signal, e.g., left or right), a driver-indicated intended turn direction via input from the steering angle sensor 120 of the steering component 116, an initial intention of turn direction, upon an initial “turn-in,” in the context of the actuation of the turn signal, an alignment status between the tractor portion 104 and the trailer portion 106 (including a direction of orientation of the tractor portion 104 and of the trailer portion 106), a turn direction of the tractor-trailer 100 (the combination of the tractor portion 104 and the trailer portion 106) by assessing the orientation of the tractor-trailer 100, and/or other suitable status events.

According to an exemplary embodiment, by analyzing the combination of status events, the one or more computing devices 118 may be configured to accurately determine whether the tractor-trailer 100 is still performing a turning maneuver such that the turn signal system controller 102 may automatically cancel a turn signal after the completion of a complex turning maneuver.

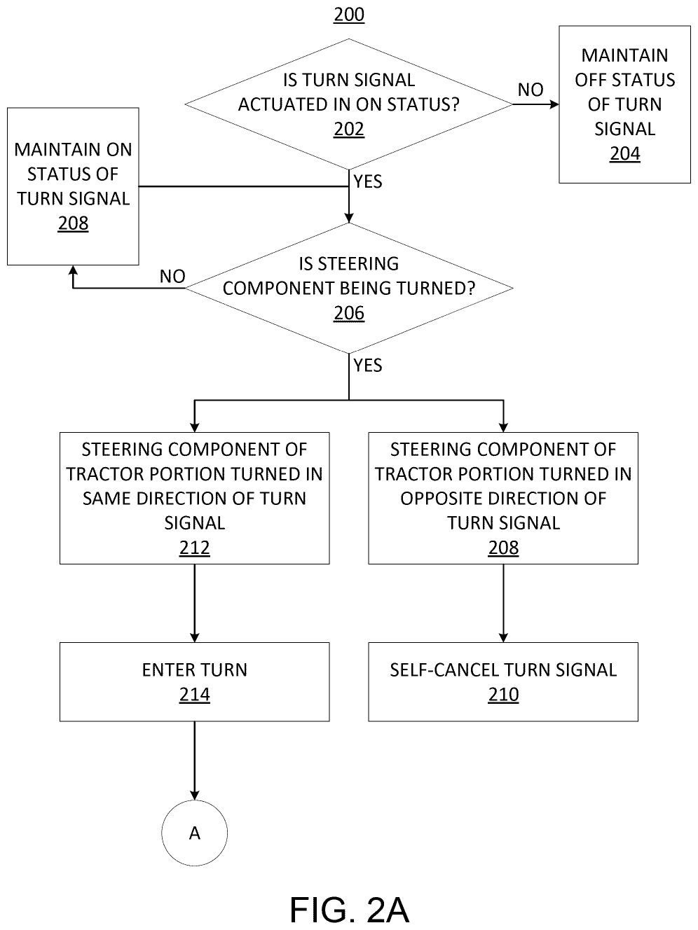

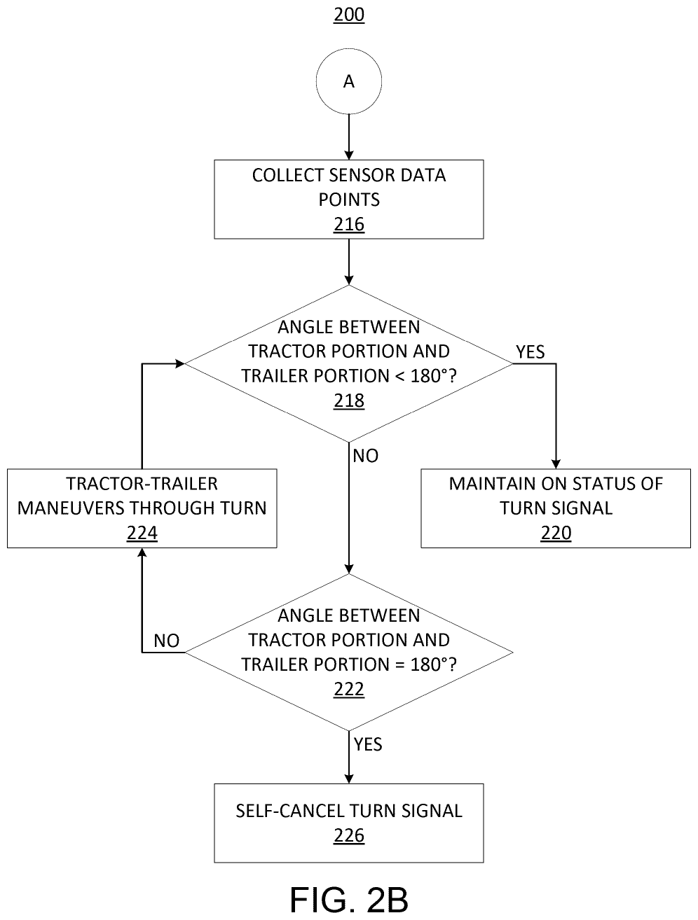

Referring now to FIGS. 2A-2B, a method 200 for activating and cancelling a turn signal is illustratively depicted, in accordance with an exemplary embodiment of the present disclosure.

At 202, it is determined whether a turn signal actuator (e.g., a turn signal stalk) is actuated with a direction indicated, actuating a turn signal (e.g., a left turn signal or a right turn signal) causing the turn signal to have an on status. According to an exemplary embodiment, the turn signal may be actuated (i.e., having an on status) in anticipation of a turn. When the turn signal actuator is not actuated, then the turn signal has an off status and, at 204, the off status is maintained. When the turn signal actuator is actuated, then the turn signal has an on status and, at 206, it is determined whether a steering component of the tractor-trailer is turned.

When the steering component of the tractor-trailer is not turned, then, at 208, the on status of the turn signal is maintained and, at 206, it is determined whether a steering component of the tractor-trailer is turned.

When the steering component of the tractor-trailer is turned and, at 208, turned in a direction opposite of the direction of the turn signal, then, at 210, the turn signal is self-cancelled.

When the steering component of the tractor-trailer is turned and, at 212, turned in a same direction as that of the turn signal, then, at 214, the driver of the tractor-trailer may enter a turn. According to an exemplary embodiment, when performing a Button Hook turn, the driver may turn the steering component of the tractor-trailer after the tractor-trailer has passed an apex of the turn.

Prior to a turning maneuver, the tractor portion and the trailer portion of the tractor-trailer are aligned in a straight orientation, with the trajectory being aligned with a steering direction of the tractor-trailer. According to an exemplary embodiment, during the turning maneuver, a driver may manually turn on (actuate) the turn signal and the tractor portion may be steered in a direction of turn, turning the front wheels and causing an angle between the tractor portion axis and the trailer portion axis to be less than 180° as the tractor-trailer assumes a turning trajectory. As the turn continues, the tractor portion may be counter-steered in a direction opposite of the turn, causing the angle between the tractor portion axis and the trailer portion axis to remain less than 180°. As the turn continues, the tractor portion may then be driven straight, causing the angle between the tractor portion and the trailer portion to be equal to 180° at the conclusion of the turning maneuver.

At 216, one or more sensors collect one or more data points pertaining to a position of the tractor portion to the trailer portion of the tractor-trailer. The one or more computing devices may be configured to analyze these one or more data portions to determine an angle between the tractor portion and the trailer portion.

At 218, it is determined whether the angle between the tractor portion and the trailer portion is less than 180°. When the angle between the tractor portion and the trailer portion is less than 180°, then, at 220, the on status of the turn signal is maintained. When the angle between the tractor portion and the trailer portion is not less than 180° then, at 222, it is determined whether the angle between the tractor portion and the trailer portion is equal to 180°.

When the angle between the tractor portion and the trailer portion is not equal to 180°, then, at 224, then the tractor-trailer may continue maneuvering through the turn and, 218, it is determined whether the angle between the tractor portion and the trailer portion is less than 180°.

When the angle between the tractor portion and the trailer portion is equal to 180° for a set amount of time, then, at 226, it may be indicated that the turning maneuver is complete and the turn signal may be cancelled. According to an exemplary embodiment, the set amount of time may be less than or equal to 2 seconds. It is noted, however, that the set amount of time may be other values (e.g., greater than 2 seconds) while maintaining the spirit and functionality of the present disclosure. According to an exemplary embodiment, the angle between the tractor portion and the trailer portion may be measured via an analysis of a steering input and/or via other suitable means.

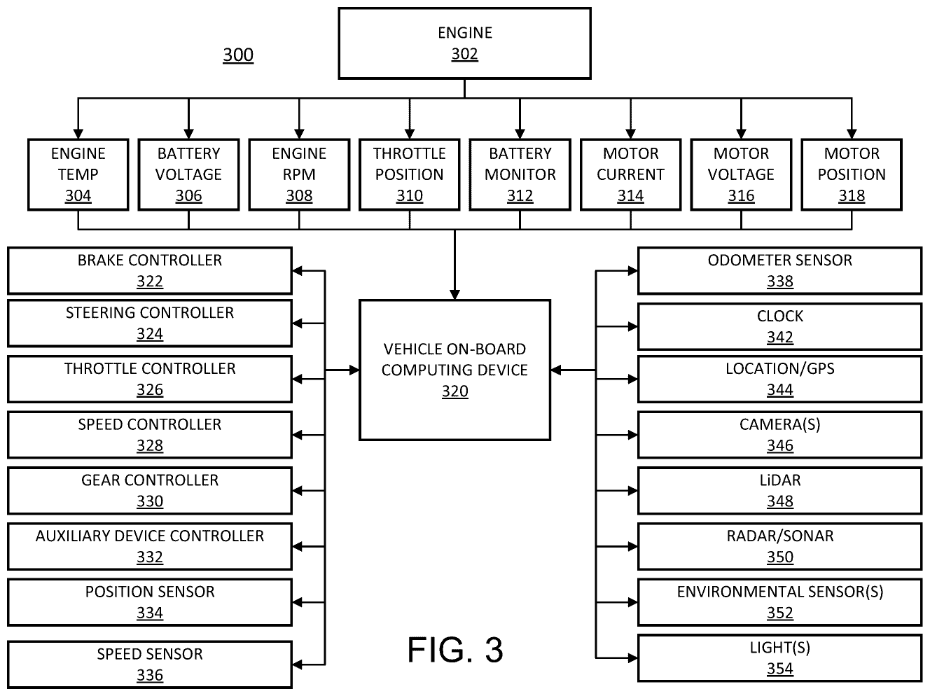

Referring now to FIG. 3, an example vehicle system architecture 300 for a vehicle is provided, in accordance with an exemplary embodiment of the present disclosure. The following discussion of vehicle system architecture 300 is sufficient for understanding one or more components of tractor-trailer 100.

As shown in FIG. 3, the vehicle system architecture 300 may comprise an engine, motor or propulsive device 302 and various sensors 304-318 for measuring various parameters of the vehicle system architecture 300. In gas-powered or hybrid vehicles having a fuel-powered engine, the sensors 304-318 may comprise, for example, an engine temperature sensor 304, a battery voltage sensor 306, an engine Rotations Per Minute (RPM) sensor 308, and/or a throttle position sensor 310. If the vehicle is an electric or hybrid vehicle, then the vehicle may comprise an electric motor, and accordingly may comprise sensors such as a battery monitoring system 312 (to measure current, voltage and/or temperature of the battery), motor current 314 and voltage 316 sensors, and motor position sensors such as resolvers and encoders 318.

Operational parameter sensors that are common to both types of vehicles may comprise, for example: a position sensor 334 such as an accelerometer, gyroscope and/or inertial measurement unit; a speed sensor 336; and/or an odometer sensor 338. The vehicle system architecture 300 also may comprise a clock 342 that the system uses to determine vehicle time and/or date during operation. The clock 342 may be encoded into the vehicle on-board computing device 320, it may be a separate device, or multiple clocks may be available.

The vehicle system architecture 300 also may comprise various sensors that operate to gather information about the environment in which the vehicle is traveling. These sensors may comprise, for example: a location sensor 344 (for example, a Global Positioning System (GPS) device); object detection sensors such as one or more cameras 346; a LiDAR sensor system 348; and/or a RADAR and/or a sonar system 350. The sensors also may comprise environmental sensors 352 such as, e.g., a humidity sensor, a precipitation sensor, a light sensor, and/or ambient temperature sensor. The object detection sensors may be configured to enable the vehicle system architecture 300 to detect objects that are within a given distance range of the vehicle in any direction, while the environmental sensors 352 may be configured to collect data about environmental conditions within the vehicle's area of travel. According to an exemplary embodiment, the vehicle system architecture 300 may comprise one or more lights 354 (e.g., headlights, flood lights, flashlights, etc.).

During operations, information may be communicated from the sensors to an on-board computing device 320 (e.g., computing device 118, computing device 400). The on-board computing device 320 may be configured to analyze the data captured by the sensors and/or data received from data providers and may be configured to optionally control operations of the vehicle system architecture 300 based on results of the analysis. For example, the on-board computing device 320 may be configured to control: braking via a brake controller 322; direction via a steering controller 324; speed and acceleration via a throttle controller 326 (in a gas-powered vehicle) or a motor speed controller 328 (such as a current level controller in an electric vehicle); a differential gear controller 330 (in vehicles with transmissions); and/or other controllers. The brake controller 322 may comprise a pedal effort sensor, pedal effort sensor, and/or simulator temperature sensor, as described herein.

Geographic location information may be communicated from the location sensor 344 to the on-board computing device 320, which may then access a map of the environment that corresponds to the location information to determine known fixed features of the environment such as streets, buildings, stop signs and/or stop/go signals. Captured images from the cameras 346 and/or object detection information captured from sensors such as LiDAR 348 may be communicated from those sensors to the on-board computing device 320. The object detection information and/or captured images may be processed by the on-board computing device 320 to detect objects in proximity to the vehicle. Any known or to be known technique for making an object detection based on sensor data and/or captured images may be used in the embodiments disclosed in this document.

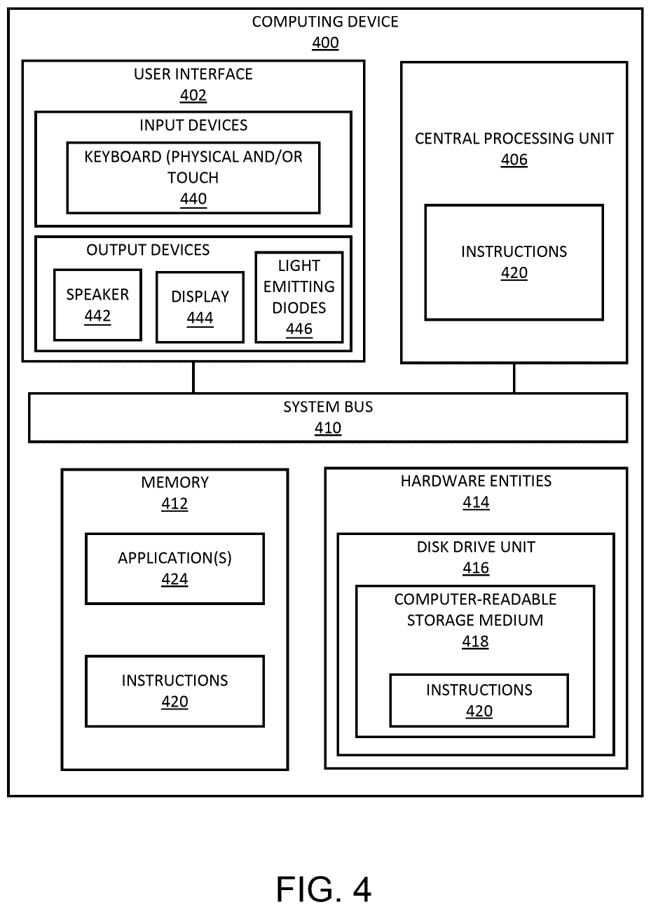

Referring now to FIG. 4, an illustration of an example architecture for a computing device 400 is provided. According to an exemplary embodiment, one or more functions of the present disclosure may be implemented by a computing device such as, e.g., computing device 400 or a computing device similar to computing device 400. Computing device 400 may be a quantum computer, a classical computer, and/or have one or more components configured to perform one or more quantum and/or classical computing functions. Computing device 118 may be an example of computing device 400 and/or may comprise one or more components of computing device 400.

The hardware architecture of FIG. 4 represents one example implementation of a representative computing device configured to implement at least a portion of the systems/devices (e.g., tractor-trailer 100) and method(s)/control logic(s) (e.g., method 200) described herein.

Some or all components of the computing device 400 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 4, the computing device 400 may comprise a user interface 402 (e.g., a graphical user interface), a Central Processing Unit (“CPU”) 406, a system bus 410, a memory 412 connected to and accessible by other portions of computing device 400 through system bus 410, and hardware entities 414 connected to system bus 410. The user interface may comprise input devices and output devices, which may be configured to facilitate user-software interactions for controlling operations of the computing device 400. The input devices may comprise, but are not limited to, a physical and/or touch keyboard 440. The input devices may be connected to the computing device 400 via a wired or wireless connection (e.g., a Bluetooth® connection). The output devices may comprise, but are not limited to, a speaker 442, a display 444, and/or light emitting diodes 446.

At least some of the hardware entities 414 may be configured to perform actions involving access to and use of memory 412, which may be a Random Access Memory (RAM), a disk driver and/or a Compact Disc Read Only Memory (CD-ROM), among other suitable memory types. Hardware entities 414 may comprise a disk drive unit 416 comprising a computer-readable storage medium 418 on which may be stored one or more sets of instructions 420 (e.g., programming instructions such as, but not limited to, software code) configured to implement one or more of the methodologies, procedures, or functions described herein. The instructions 420 may also reside, completely or at least partially, within the memory 412 and/or within the CPU 406 during execution thereof by the computing device 400.

The memory 412 and the CPU 406 may also constitute machine-readable media. The term “machine-readable media”, as used here, refers to a single medium or multiple media (e.g., a centralized or distributed database, and/or associated caches and servers) that store the one or more sets of instructions 420. The term “machine-readable media”, as used here, also refers to any medium that is capable of storing, encoding, or carrying a set of instructions 420 for execution by the computing device 400 and that cause the computing device 400 to perform any one or more of the methodologies of the present disclosure.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical), Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A turn signal control system, comprising:
one or more sensors, coupled to a tractor-trailer,
wherein:
the tractor-trailer comprises a tractor portion and a trailer portion, and
the one or more sensors are configured to detect one or more data points
pertaining to a position of the tractor portion in relation to the trailer portion;
one or more computing devices, each comprising a processor and a memory, configured to analyze the one or more data points to determine an angle between the tractor portion and the trailer portion; and
a controller configured to automatically cancel a turn signal based on one or more factors,
wherein the one or more factors comprise the angle between the tractor portion and the trailer portion.

2. The turn signal control system of claim 1, wherein:
the tractor-trailer further comprises:
a steering component; and
a steering angle sensor configured to detect a steering angle of the steering component, and
the one or more factors further comprise the angle of the steering component.

3. The turn signal system of claim 1, further comprising a manual turn signal actuator configured to enable a driver to actuate a turn signal such that the turn signal has an on status and a direction.

4. The turn signal system of claim 1, wherein the computing device is further configured to determine whether the angle between the tractor portion and the trailer portion is less than 180°.

5. The turn signal system of claim 4, wherein the controller is further configured to maintain an on status of the turn signal when the angle between the tractor portion and the trailer portion is less than 180°.

6. The turn signal system of claim 4, wherein, when the angle between the tractor portion and the trailer portion is not less than 180°, the computing device is further configured to determine whether the angle between the tractor portion and the trailer portion equals 180°.

7. The turn signal system of claim 6, wherein, when the angle between the tractor portion and the trailer portion is equal to 180° for a set amount of time, the controller is further configured to cancel the turn signal, causing the turn signal to have an off status.

8. The turn signal system of claim 1, further comprising the tractor-trailer.

9. The turn signal system of claim 8, wherein the tractor-trailer comprises:
one or more left turn signal indicators configured to indicate that the turn signal is a left turn signal with an on status; and
one or more right turn signal indicators configured to indicate that the turn signal is a right turn signal is a right turn signal with an on status.

10. The turn signal system of claim 8, wherein:
the tractor-trailer comprises a fifth wheel, and
the one or more sensors are coupled to the fifth wheel.

11. A method for controlling a turn signal, comprising:
detecting, using one or more sensors coupled to a tractor-trailer, one or more data points pertaining to a position of a tractor portion of the tractor-trailer in relation to a trailer portion of the tractor trailer;
analyzing, using one or more computing devices, each comprising a processor and a memory, the one or more data points to determine an angle between the tractor portion and the trailer portion; and
using a controller, automatically cancelling a turn signal based on one or more factors,
wherein the one or more factors comprise the angle between the tractor portion and the trailer portion.

12. The method of claim 11,
wherein:
the tractor-trailer further comprises:
a steering component; and
a steering angle sensor configured to detect a steering angle of the steering component, and
the one or more factors further comprise the angle of the steering component; and
further comprising detecting, using the steering angle sensor, the angle of the steering component.

13. The method of claim 11, further comprising actuating, using a manual turn signal actuator, the turn signal such that the turn signal has an on status and a direction.

14. The method of claim 13, wherein the manual turn signal actuator is configured to enable a driver to actuate the turn signal.

15. The method of claim 11, further comprising determining, using the computing device, whether the angle between the tractor portion and the trailer portion is less than 180°.

16. The method of claim 15, further comprising maintaining, using the controller, an on status of the turn signal when the angle between the tractor portion and the trailer portion is less than 180°.

17. The method of claim 15, further comprising, when the angle between the tractor portion and the trailer portion is not less than 180°, determining, using the computing device, whether the angle between the tractor portion and the trailer portion equals 180°.

18. The method of claim 17, further comprising, when the angle between the tractor portion and the trailer portion is equal to 180° for a set amount of time, cancelling, using the controller, the turn signal, causing the turn signal to have an off status.

19. The method of claim 11, wherein the tractor-trailer further comprises:
one or more left turn signal indicators configured to indicate that the turn signal is a left turn signal with an on status; and
one or more right turn signal indicators configured to indicate that the turn signal is a right turn signal is a right turn signal with an on status.

20. The method of claim 11, wherein:
the tractor-trailer comprises a fifth wheel, and
the one or more sensors are coupled to the fifth wheel.
